(19) United States
(12) Patent Application Publication
(10) Pub. No.: US 2025/0258909 A1
(43) Pub. Date: Aug. 14, 2025

(54) PRESERVING DLL HOOKS

(71) Applicant: SentinelOne, Inc., Mountain View, CA (US)

(72) Inventors: Anil Gupta, Bangalore (IN); Harinath Vishwanath Ramchetty, Bangalore (IN)

(73) Assignee: SentinelOne, Inc., Mountain View, CA (US)

(21) Appl. No.: 19/057,913

(22) Filed: Feb. 19, 2025

Related U.S. Application Data
(63) Continuation of application No. 18/398,791, filed on Dec. 28, 2023, now Pat. No. 12,259,967.
Application No. 18/398,791 is a continuation of application No. 17/374,087, filed on Jul. 13, 2021, now Pat. No. 11,899,782.

(51) Int. Cl. G06F 21/54; G06F 21/55; G06F 21/57

(52) U.S. Cl. CPC G06F 21/54; G06F 21/554; G06F 21/577

(57) ABSTRACT

DLL hooks are protected by mapping the starting address of the new executable to a sample of the former executable. Attempts to read the starting address are responded to with the sample of the former executable. Attempts to write to the starting address are responded to with confirmation of success without actually writing data. Debuggers are detected upon launch or by evaluating an operating system. A component executing in the kernel denies debugging privileges to prevent inspection and modification of DLL hooks.

### CROSS-REFERENCE TO RELATED APPLICATIONS

This application is a continuation of U.S. application Ser. No. 18/398,791, filed Dec. 28, 2023, which is a continuation of U.S. application Ser. No. 17/374,087, filed Jul. 13, 2021, each of which is incorporated herein by reference in its entirety.

### BACKGROUND

A dynamic link library (DLL) includes commonly used functions that are linked with an application when it is loaded into memory. Addresses of the functions of the DLL in memory are provided to the application upon instantiation. Typically, a DLL is provided as part of the operating system. In some instances, security software may substitute modified functions in the place of one or more functions of a dynamic link library (DLL). The substitution of a security function in the place of a standard DLL function may be referred to as a “DLL hook.”

### BRIEF SUMMARY OF THE INVENTION

The systems and methods disclosed herein provide an improved approach for implementing DLL hooks. In one embodiment, a security DLL may be associated with a native DLL that is redirected to the security DLL, where the security DLL performs a threat mitigation function and the native DLL is restricted from performing such a function.

### BRIEF DESCRIPTION OF THE FIGURES

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIGS. 1A to 1C are schematic block diagrams of network environments for performing methods in accordance with an embodiment of the present invention;

FIGS. 2A to 2C are schematic block diagrams illustrating components for protecting DLL hooks in accordance with an embodiment of the present invention;

FIG. 3 is a process flow diagram of a method for generating protectable DLL hooks in accordance with an embodiment of the present invention;

FIG. 4A is a process flow diagram of a method for preventing detection of DLL hooks in accordance with an embodiment of the present invention;

FIG. 4B is a process flow diagram of a method for preventing modification of DLL hooks in accordance with an embodiment of the present invention;

FIG. 5 is a process flow diagram of a method for handling use of a debugger in order to protect DLL hooks files in accordance with an embodiment of the present invention; and

FIG. 6 is a schematic block diagram of a computer system suitable for implementing methods in accordance with embodiments of the present invention.

### DETAILED DESCRIPTION

It will be readily understood that the components of the invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Embodiments in accordance with the invention may be embodied as an apparatus, method, or computer program product. Accordingly, the invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the invention may be written m any combination of one or more programming languages, including an object-oriented programming language such as Java, Smalltalk, C++, or the like and conventional procedural programming languages, such as the “C” programming language or similar programming languages, and may also use descriptive or markup languages such as HTML, XML, JSON, and the like. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

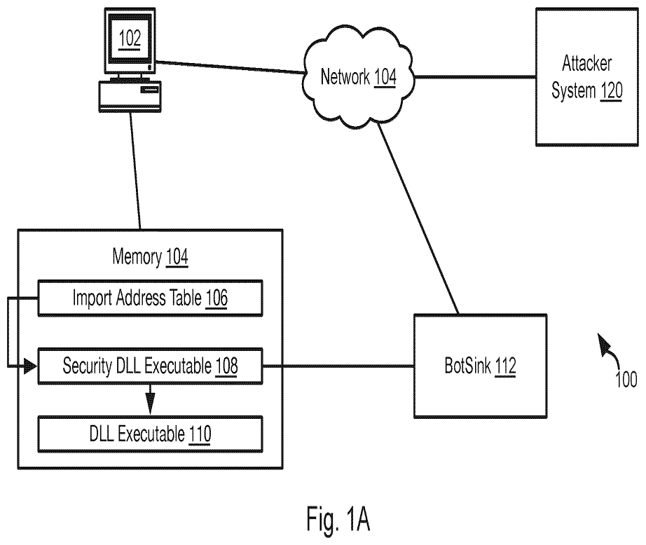

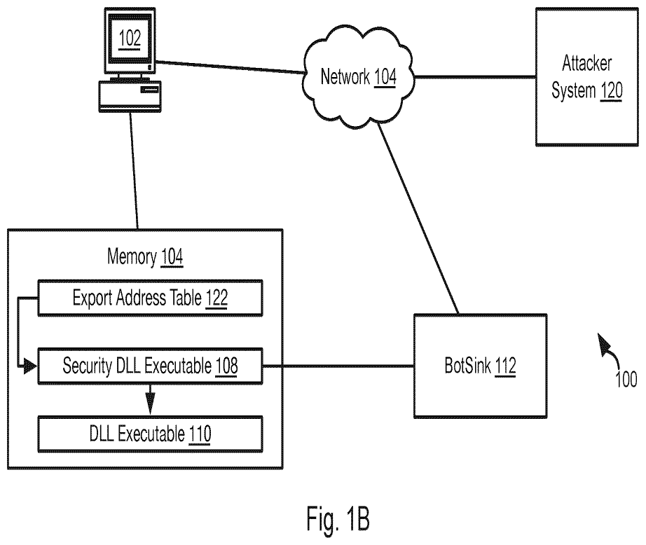

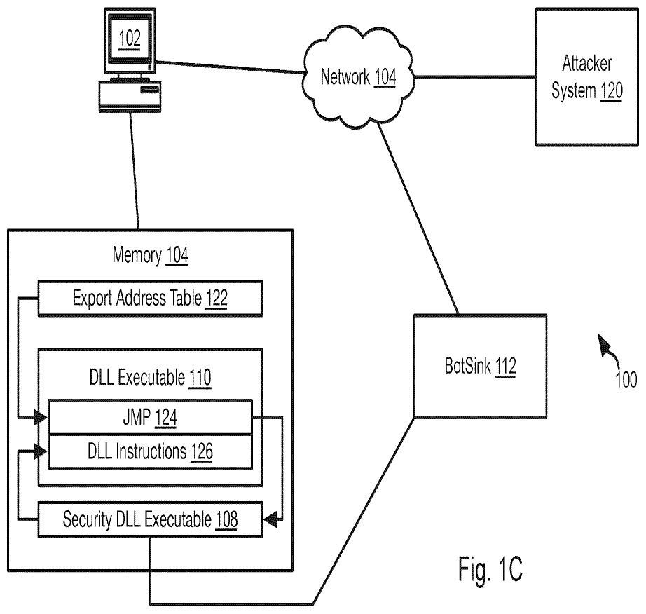

Referring to FIG. 1A, the methods disclosed herein may be practiced in a network environment 100 including a computer system 102 connected to a network, such as the Internet, local area network (LAN), wide area network (WAN), or other type of network. The computer system 102 may be a user endpoint, such as a desktop or laptop computer, tablet computer, smartphone, wearable computing device, or other type of computing device.

An application executing on a computer system and stored in memory 104 may include import address table (IAT) 106. Each memory location in the IAT 106 may refer to the starting address in the memory 104 of a dynamic link library (DLL) function. As known in the art, a DLL is a set of functions used by multiple applications. Applications are incorporate the DLL and make calls to the functions of the DLL but need not include the executables for the functions. Instead, when the application is loaded into memory, the IAT 106 is used to link the application to the locations of the DLL executables 110. When a call to a DLL function is generated by the application, the application invokes the DLL executable 110 pointed to in the entry of the IAT 106 corresponding to that DLL function.

A security application, such as an anti-virus, anti-malware, or deception-based security application, may substitute or augment the functionality of a given DLL executable 110. For example, an IAT DLL hook may be implemented whereby an entry in the IAT 106 referencing the starting address of the DLL executable 110 is modified to refer to a security DLL executable 108 that may either replace the functionality of the executable 110 or perform security functions followed by invoking execution of the DLL executable.

In some embodiments, the security DLL executable 108 may operate in combination with a BotSink 112 to provide deception-based security. The BotSink 112 may create the DLL hook to the security DLL executable 108 and/or execution of the security DLL executable 108 may result in exchange of information with the BotSink 112. It shall be understood that the system for protecting DLL hooks may be used with any system implementing DLL hooks.

The BotSink 112 either alone or with use of DLL hooks may implement any of the method for detecting and engaging malicious code disclosed in the applications of Table 1 (hereinafter “the incorporated applications”), which are hereby incorporated herein by reference in their entirety.

TABLE 1
Incorporated Applications

| Filing | | |
|---|---|---|
| Date | Ser. No. | Title |
| Nov. 7, 2013 | 14/074,532 | Methods and Apparatus for |
| | | Redirecting Attacks on a Network |
| May 7, 2014 | 61/989,965 | Distributed System for Bot Detection |
| Aug. 12, 2014 | 14/458,065 | Emulating Successful Shellcode |
| | | Attacks |
| Aug. 12, 2014 | 14/458,026 | Distributed System for Bot Detection |
| Aug. 22, 2014 | 14/466,646 | Evaluating URLS For Malicious |
| | | Content |
| Nov. 20, 2014 | 14/549,112 | System And Method For Directing |
| | | Malicious Activity To A Monitoring |
| | | System |
| Jul. 21, 2015 | 14/805,202 | Monitoring Access Of Network |
| | | Darkspace |
| Dec. 10, 2015 | 14/965,574 | Database Deception In Directory |
| | | Services |
| Apr. 29, 2016 | 15/142,860 | Authentication Incident Detection and |
| | | Management |
| May 12, 2016 | 15/153,471 | Luring Attackers Towards Deception |
| | | Servers |
| May 17, 2016 | 15/157,082 | Emulating Successful Shellcode |
| | | Attacks |
| Jul. 7, 2016 | 15/204,779 | Detecting Man-In-The-Middle Attacks |
| Nov. 23, 2016 | 15/360,117 | Implementing Decoys in Network |
| | | Endpoints |
| Dec. 19, 2016 | 15/383,522 | Deceiving Attackers in Endpoint |
| | | Systems |
| Sep. 5, 2017 | 15/695,952 | Ransomware Mitigation System |
| Feb. 9, 2018 | 15/893,176 | Implementing Decoys In A Network |
| | | Environment |
| May 22, 2019 | 16/420,074 | Deceiving Attackers in Endpoint |
| | | Systems |
| May 31, 2019 | 201921021696 | Implementing Decoys in a Network |
| | | Environment |
| Aug. 16, 2019 | 16/543,189 | Deceiving Attackers Accessing Active |
| | | Directory Data |
| Apr. 15, 2020 | 16/849,813 | Deceiving Attackers Accessing |
| | | Network Data |

In any of the incorporated applications, where operating system commands are intercepted or modified, DLL hooks may be used. For example, U.S. application Ser. No. 15/383,522 describes a system that intercepts certain operating system commands to determine whether the commands reference protected data. The interception of these commands may be implemented by DLL hooks substituted for DLL executables for these commands. In another example, U.S. application Ser. No. 15/695,952 describes a system that modifies file system commands to mitigate ransomware attacks. File system commands may be modified by using a DLL hook to replace a file system command executable with a modified DLL executable performing the modified file system commands.

The computer system 102 may be infiltrated by an attacker system 120 accessing the computer system I 02 by means of the network I 04 or an executable operating in the computer system I 02. An attacker system may seek to probe defensive measures implemented on the computer system 102, including the existence of DLL hooks. This may include rewriting the IAT 106 to ensure that all entries refer to their corresponding DLL executables 110 or evaluating the executable code referenced by entries in the IAT 106 to ensure that the executable code match the expected DLL executable 110 for a given operating system vendor or other source. The systems and methods disclosed herein hinder such attempts as described in detail below.

FIG. 1B illustrates an export address table (EAT) DLL hook. An EAT DLL hook may be implemented by modifying the export address table 122 may include modifying the EAT of a DLL such that a reference to the starting address (memory address storing the first instruction) of the DLL executable 110 is replaced with the starting address of the security DLL executable 108. In particular, the EAT 122 of a DLL may map each function name to an offset address relative to a starting address of the DLL. The offset address may be replaced with the starting address of the DLL. In this manner, when an application is linked with the DLL, the IAT 106 will associate the starting address of the security DLL with the function name.

FIG. 1C illustrates an inline DLL hook. The EAT 122 or IAT 106 stores pointers mapping a function name to the starting address of the DLL executable 110. The instruction stored at the starting address (or any of the first N instructions stored at the first N memory locations including and following the starting address) is modified to include a jump (JMP) instruction 124 that instructs an executing processor to continue execution at an address referenced by the JMP instruction 124, that address being the starting address of the security DLL executable 108. The security DLL executable 108 may replace the DLL executable 110 or may include a JMP instruction back to the DLL executable 110.

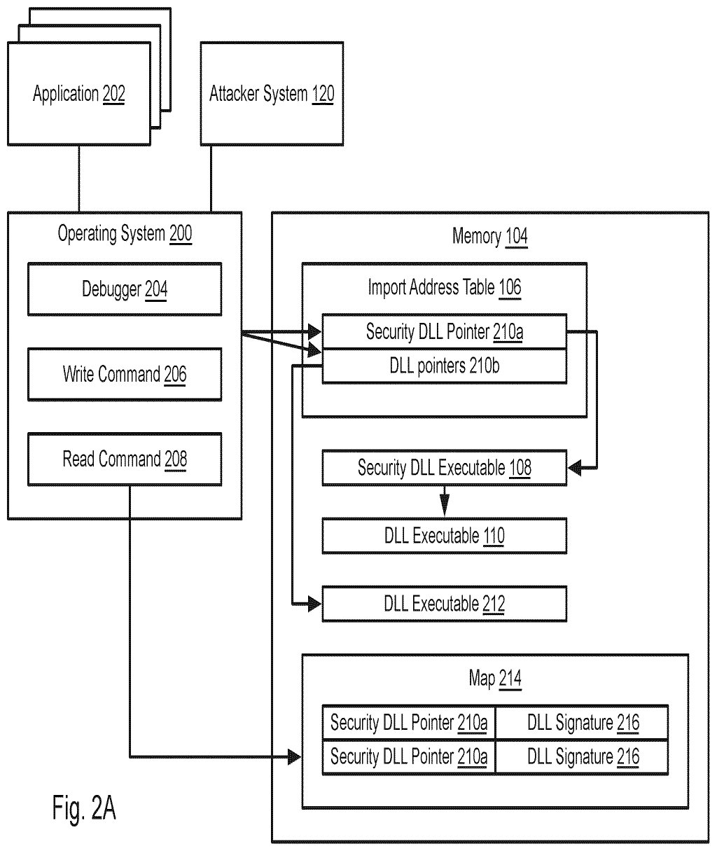

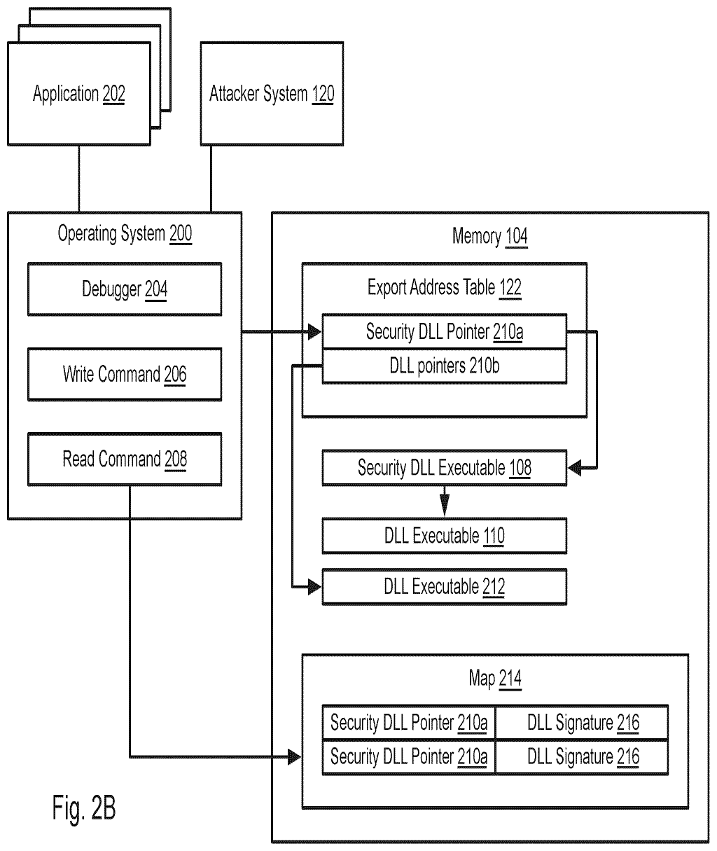

Referring to FIG. 2A, applications 202 on the computer system 102 may operate in the context of an operating system 200. The applications 202 may make calls to DLL functions through the operating system 200. The operating system 200 may also include functionality such as a debugger 204 or functions that may be used by a debugger (e.g., placing of break points, inspection of memory). The operating system 200 may further include tools enabling reading from or writing to address locations in the memory 104. These tools may be tools used by a debugger or administrator and may include at least a write command executable 206 and a read command executable 208. For example, the command executable may include windbg debugger controls such as bp (inserts break point instruction), eb (edit/modify bytes at a given address with a given value), uf (un-assemble instructions at a given address), or db (dumps bytes at a given address). As described in greater detail below, each of the write command executable 206 and read command executable 208 may be modified to function according to the methods described herein.

For IAT hooks, the memory 104 may include the IAT 106 including one or more security DLL pointers 210a and possibly one or more DLL pointers 210b that point to a DLL executable 212 as specified by an operating system vendor or other source of the DLL. As outlined above, the DLL pointers 210a may point to a security DLL executable 108. Each DLL executable 108 may completely replace a DLL executable 110 such that the DLL executable 110 is not invoked. Alternatively, each DLL executable 108 may call the DLL executable 110 that it replaces.

The replacement of a pointer to a DLL executable 110 with security DLL pointers 210a may be performed by a software module referred to herein as “the DLL hook module,” which may be the BotSink 112, an agent of the BotSink 112 executing on the computer system 102, or other executable code configured to cause performance of the functions of the DLL hook module described herein.

Before, during, or after modification of the IAT 106 to include the one or more security DLL pointers 210a, the DLL hook module may create a map 214. The map 214 may be stored in the memory 104, a persistent storage device (e.g., hard drive, NAND drive, etc.), or other storage device hosted by the computer system 102. Each entry of the maps 214 may include a security DLL pointer 210a, i.e. the starting address of a security DLL executable 108, and a DLL signature 216. The DLL signature 216 may be a representation of the DLL executable 110 referenced by an entry in the IAT 106 replaced by the security DLL pointer 210a mapped to the DLL signature 216 in the map 214.

The DLL signature 216 may be a portion of the DLL executable 110, such as the first N instructions of the DLL executable 110, where N is a predetermined integer greater than or equal to one, such as 5, 10, 100, 1 kB, or other some other value. The signature 216 may also be a hash or other representation of the entire DLL executable 110 or the first N instructions of the DLL executable 110.

FIGS. 2B and 2C illustrate implementations of EAT and inline DLL hooks, respectively. As shown in FIG. 2B, the EAT table 122 is modified to include a security DLL pointer 210a that stores the starting address of the security DLL executable 108. Upon creation of an EAT hook, the map 214 is updated as for an IAT hook: each entry includes a security DLL pointer 210a that stores the first address of the security DLL executable 108 and a DLL signature 216 for the DLL executable 210 replaced by the security DLL executable 108.

As shown in FIG. 2C, the JMP instruction in the modified DLL executable points to the starting address of the security DLL executable 108 following creation of the inline hook. The map 214 is updated in the same manner as for other types of hooks: each entry includes a security DLL pointer 210a that stores the first address of the security DLL executable 108 and a DLL signature 216 for the DLL executable 210 replaced by the security DLL executable 108. The DLL signature 216 is the signature of the DLL prior to modification to include the JMP instruction 124.

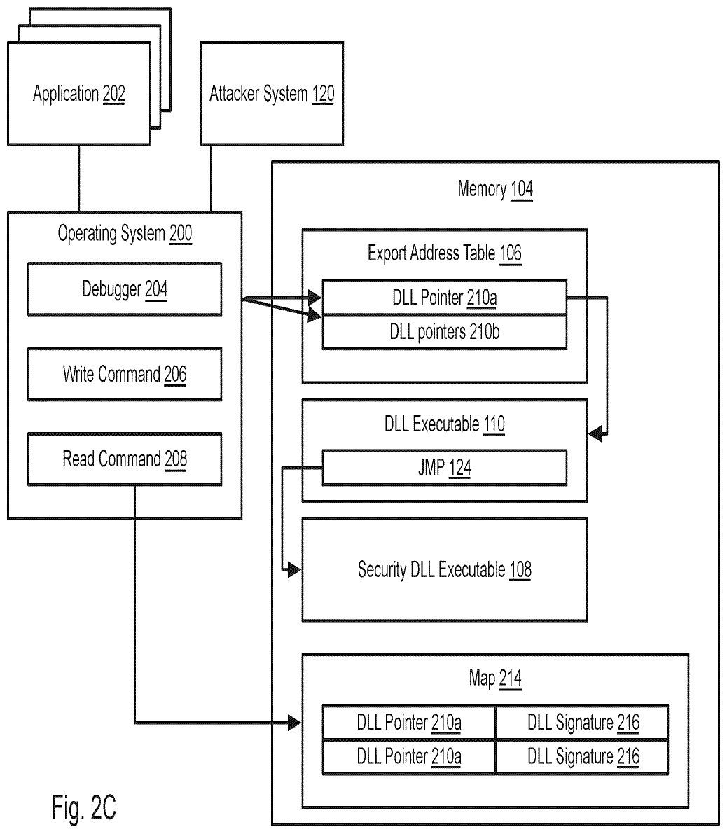

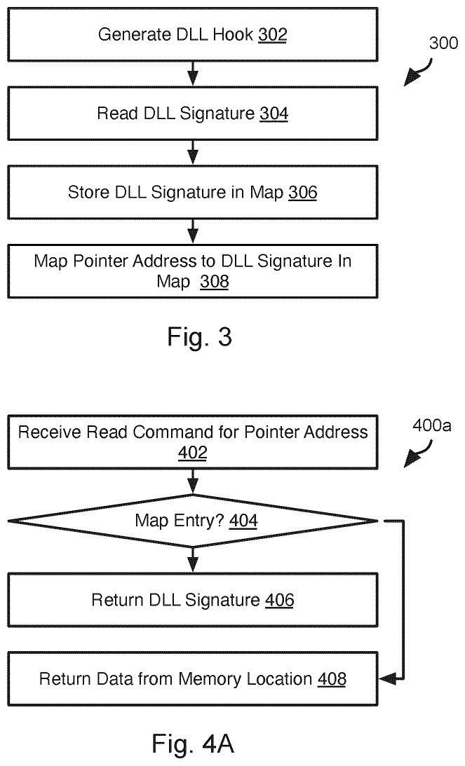

FIG. 3 illustrates a method 300 that may be executed by the DLL hook module. The method 300 is described with respect to actions performed with one DLL hook such that the method 300 may be repeated for each DLL hook that is created. The method 300 may be used for IAT, EAT, and inline DLL hooks.

The method 300 includes generating 302 a DLL hook. As described above this may include modifying an original value at a location in the IAT 106 or EAT to store the starting address of a security DLL executable 108 or placing a JMP instruction in a DLL 110 that points to the starting address of the security DLL executable 108. The method 300 may include reading 304 a DLL signature of the DLL executable 110 that was referenced by the original value. As described above, this may include reading the first N instructions of the DLL executable. The method 300 may further include storing 306 the DLL signature in the map 214 and mapping 308 the starting address of the security DLL 108 to the DLL executable. As noted above, this may include creating an entry including two values: the first value including the starting address of the security DLL 108 and the second value including the DLL signature.

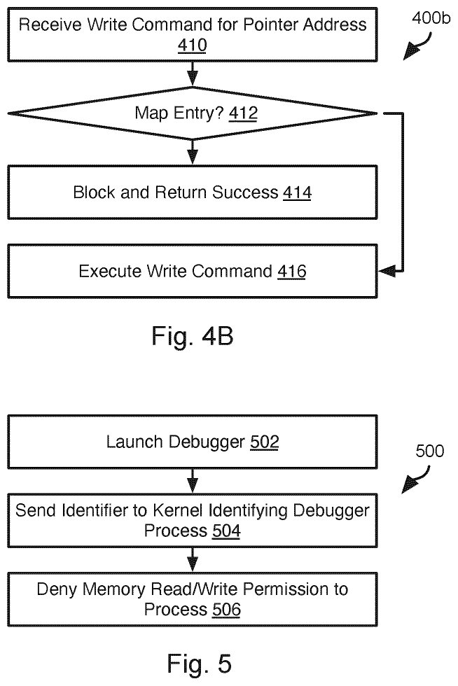

FIG. 4A illustrates a method 400a for hindering detection of DLL hooks. The method 400a may include receiving 402 a read command referencing an address in the memory 104. The read command is received from a source, such as an attacker system 120, and may invoke execution of the read command executable 208. The read command executable 208 may evaluate 404 whether the address referenced by the read command is included in an entry in the map 214. If so, the read command executable 208 may return 406 some or all of the DLL signature 216 mapped to the address referenced by the read command in the map 214. For example, the read command may specify a number of memory locations to read. Accordingly, that number of instructions from the DLL signature 216 may be returned to a source of the read command, such as by way of the operating system 200. As is apparent, the method 400a returns the instructions of the original DLL executable 110 and therefore prevents detection of the DLL hook.

If there is no entry in the map 214 including the address referenced by the read command, the read command executable 208 may read the data from the address or block of addresses referenced by the read command and return 408 the data to the source of the read command. In some instances, the read command may be blocked for other reasons, such as a determination that the source of the read command is malicious or unauthorized. The approach by which the source of the read command is determined to be malicious or unauthorized may be any known in the art or described in the incorporated applications.

FIG. 4B illustrates a method 400b for hindering overwriting of DLL hooks to restore references to original DLL executables. The method 400b may include receiving 410 a write command referencing an address in the memory 104. The write command is received from a source, such as an attacker system 120, and may invoke execution of the write command executable 206. The write command executable 206 may evaluate 412 whether the address referenced by the write command is included in an entry in the map 214. If so, the write command executable 206 may block execution of the write command (e.g., ignore the write command) and return 414 confirmation of successful execution of the write command. As is apparent, the method 400b ensures that the security DLL executable 108 is not overwritten.

If there is no entry in the map 214 including the address referenced by the write command, the write command executable 206 may execute 416 the write command by writing data from the write command to the address or block of addresses referenced by the write command and returning acknowledgment of successful completion of the write command to the source of the write command. In some instances, the write command may be blocked for other reasons, such as a determination that the source of the write command is malicious or unauthorized. The approach by which the source of the write command is determined to be malicious or unauthorized may be any known in the art or described in the incorporated applications.

Referring to FIG. 5, detection of DLL hooks may further be prevented by modifying operation of debuggers executing on the computer system 102. In an operating system such as WINDOWS, LINUX, MACOS, or the like, the operating system may grant debugging privileges to particular executables. An operating system may additionally or alternatively set a flag or otherwise modify processes that have debugging privileges. Debugging privileges may include the ability to set break points, inspect operating system components, inspect memory contents, show intermediate results of functions, directly write to memory locations, and perform other debugging functions known in the art.

The method 500 may include the operating system 200 launching 502 a debugger, i.e. an application that has or requested debugging privileges from the operating system 200. An implementing software module that implements debugging functions may be modified by the BotSink 112, the DLL hook module, or other software component. In particular, the implementing software module may be modified such that in response to launching 502 of the debugger, the implementing software may send 504 an identifier to a kernel component. The identifier may be a process token defining the privileges of the debugger. The implementing software may be or include a hooked DLL or modified operating system function responsible for launching debuggers or granting debugging privileges. The implementing software may use an API (application programming interface) of the operating system 200 to obtain the token in response to detecting launching of the debugger.

In response to receiving the identifier, the kernel component may deny 506 privileges associated with the identifier. For example, the kernel component may monitor creation of handles for the process represented by the identifier, i.e. an object that may be used to reference and access the process in a WINDOWS operating system. In response to requests to create handles for the identifier, the kernel component may remove all access bits from the handle and just set the “PROCESS_QUERY_LIMITED_INFORMATION” bit. With this bit set, commands made using the handle cannot modify any aspect of the process as a debugger, including placement of breakpoints.

Additionally or alternatively, the implementing software may, in user mode, identify all known debuggers that the operating system 200 is configured to grant debugging privileges. The resource file of these debuggers may be evaluated to determine its internal name and this internal name may be passed to the kernel component. The kernel component may then remove debugging privileges from processes including the internal name, such as by modifying handle privileges as described above.

In addition to the approaches described above with respect to FIGS. 1 through 5, additional measures may be taken to prevent DLL hooks. For example, for hooks according to any of the foregoing embodiments, a name of each security DLL executable 108 in the loader descriptor table (LDR) may be replaced with the name of the DLL executable 110 replaced by that security DLL executable 108. In another example, the GetMappedFileName( ) executable may be itself hookd and replaced with a security DLL executable 108 that is programmed to modify results returned when the GetMappedFileName( ) function is called. For example, where the result of a call to GetMappedFileName( ) would result in the name of a security DLL executable 108, the name of the DLL executable 110 replaced by that security executable DLL 108 will be returned instead.

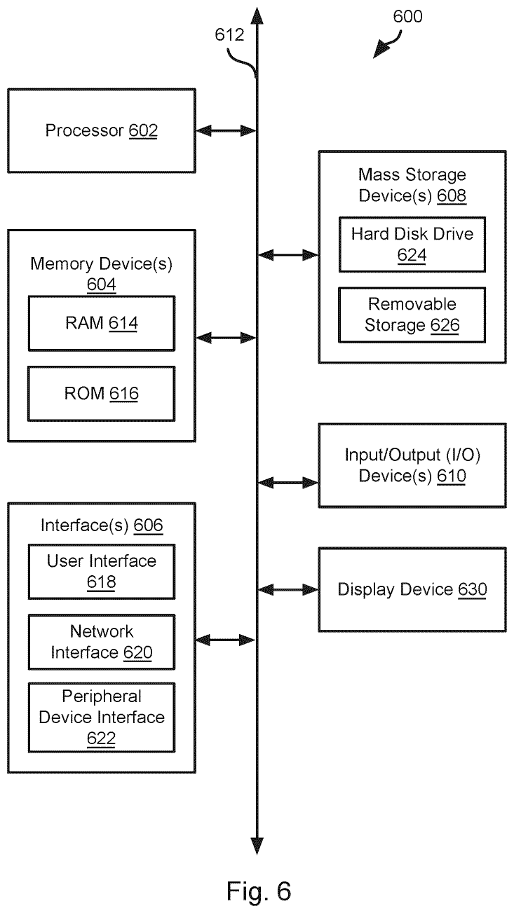

FIG. 6 is a block diagram illustrating an example computing device 600 which can be used to implement the system and methods disclosed herein. The computer system 102, BotSink 112, and attacker system 120 may have some or all of the attributes of the computing device 600. In some embodiments, a cluster of computing devices interconnected by a network may be used to implement any one or more components of the invention.

Computing device 600 may be used to perform various procedures, such as those discussed herein. Computing device 600 can function as a server, a client, or any other computing entity. Computing device can perform various monitoring functions as discussed herein, and can execute one or more application programs, such as the application programs described herein. Computing device 600 can be any of a wide variety of computing devices, such as a desktop computer, a notebook computer, a server computer, a handheld computer, tablet computer and the like.

Computing device 600 includes one or more processor(s) 602, one or more memory device(s) 604, one or more interface(s) 606, one or more mass storage device(s) 608, one or more Input/Output (I/O) device(s) 610, and a display device 630 all of which are coupled to a bus 612. Processor(s) 602 include one or more processors or controllers that execute instructions stored in memory device(s) 604 and/or mass storage device(s) 608. Processor(s) 602 may also include various types of computer-readable media, such as cache memory.

Memory device(s) 604 include various computer-readable media, such as volatile memory (e.g., random access memory (RAM) 614) and/or nonvolatile memory (e.g., read-only memory (ROM) 616). Memory device(s) 604 may also include rewritable ROM, such as Flash memory.

Mass storage device(s) 608 include various computer readable media, such as magnetic tapes, magnetic disks, optical disks, solid-state memory (e.g., Flash memory), and so forth. As shown in FIG. 6, a particular mass storage device is a hard disk drive 624. Various drives may also be included in mass storage device(s) 608 to enable reading from and/or writing to the various computer readable media. Mass storage device(s) 608 include removable media 626 and/or non-removable media.

1/0 device(s) 610 include various devices that allow data and/or other information to be input to or retrieved from computing device 600. Example I/O device(s) 610 include cursor control devices, keyboards, keypads, microphones, monitors or other display devices, speakers, printers, network interface cards, modems, lenses, CCDs or other image capture devices, and the like.

Display device 630 includes any type of device capable of displaying information to one or more users of computing device 600. Examples of display device 630 include a monitor, display terminal, video projection device, and the like.

Interface(s) 606 include various interfaces that allow computing device 600 to interact with other systems, devices, or computing environments. Example interface(s) 606 include any number of different network interfaces 620, such as interfaces to local area networks (LANs), wide area networks (WANs), wireless networks, and the Internet. Other interface(s) include user interface 618 and peripheral device interface 622. The interface(s) 606 may also include one or more user interface elements 618. The interface(s) 606 may also include one or more peripheral interfaces such as interfaces for printers, pointing devices (mice, track pad, etc.), keyboards, and the like.

Bus 612 allows processor(s) 602, memory device(s) 604, interface(s) 606, mass storage device(s) 608, and I/O device(s) 610 to communicate with one another, as well as other devices or components coupled to bus 612. Bus 612 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 600, and are executed by processor(s) 602. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

1. (canceled)

2. A method comprising:
modifying memory to include a reference to a dynamic link library (DLL) such that invocation of a function associated with a native DLL is redirected to the DLL;
generating an entry, wherein the entry comprises the reference to the DLL and a native DLL signature;
receiving, from a source, instructions referencing an address in memory;
restricting the address in memory from access by the source based on a determination that the address in memory corresponds to the entry;
in response to a request to write to the address, blocking writing and returning a confirmation of execution of the request; and
returning at least a portion of the native DLL signature back to the source.

3. The method of claim 2, wherein the entry is in a mapping stored in memory.

4. The method of claim 2, wherein the reference to the DLL is a second address in memory.

5. The method of claim 2, wherein the native DLL signature is a representation of the native DLL.

6. The method of claim 2, wherein the native DLL signature is a portion of the native DLL.

7. The method of claim 2, wherein the native DLL signature is a hash of the native DLL.

8. The method of claim 2, wherein the native DLL signature comprises instructions of the native DLL.

9. A system comprising:
a processing circuitry; and
a memory, the memory containing instructions that, when executed by the processing circuitry, configure the system to:
modify the memory to include a reference to a dynamic link library (DLL) such that invocation of a function associated with a native DLL is redirected to the DLL;
generate an entry, wherein the entry comprises the reference to the DLL and a native DLL signature of the native DLL;
receive, from a source, instructions referencing an address in the memory;
restrict the address in memory from access by the source based on a determination that the address in memory corresponds to the entry;
in response to a request to write to the address, blocking writing and returning a confirmation of execution of the request; and
returning at least a portion of the native DLL signature back to the source.

10. The system of claim 9, wherein the entry is in a mapping stored in memory.

11. The system of claim 9, wherein the reference to the DLL is a second address in memory.

12. The system of claim 9, wherein the native DLL signature is a representation of the native DLL.

13. The system of claim 9, wherein the native DLL signature is a representation of the native DLL.

14. The system of claim 9, wherein the native DLL signature is a hash of the native DLL.

15. A non-transitory computer readable medium having stored thereon instructions for causing one or more processing units to execute a process for generating a representation for behavior determination, the process comprising:
modifying memory to include a reference to a dynamic link library (DLL) such that invocation of a function associated with a native DLL is redirected to the DLL using the reference to the DLL;
generating an entry, wherein the entry comprises the reference to the DLL and a native DLL signature of the native DLL;
receiving, from a source, instructions referencing an address in memory;
restricting the address in memory from access by the source based on a determination that the address in memory corresponds to the entry;
in response to a request to write to the address, blocking writing and returning a confirmation of execution of the request; and
returning at least a portion of the native DLL signature back to the source.

16. The non-transitory computer readable medium of claim 15, wherein the entry is in a mapping stored in memory.

17. The non-transitory computer readable medium of claim 15, wherein the reference to the security DLL is a second address in memory.

18. The non-transitory computer readable medium of claim 15, wherein the native DLL signature is a representation of the native DLL.

19. The non-transitory computer readable medium of claim 15, wherein the native DLL signature is a portion of the native DLL.

20. The non-transitory computer readable medium of claim 15, wherein the native DLL signature is a hash of the native DLL.

21. The non-transitory computer readable medium of claim 15, wherein the native DLL signature comprises instructions of the native DLL.
